(19) United States
(12) Patent Application Publication
(10) Pub. No.: US 2021/0140401 A1
(43) Pub. Date: May 13, 2021

(54) POWER-ADJUSTABLE WAVE POWER GENERATOR

(71) Applicant: SHANXI PINGYAO REDUCER CO., LTD, Jinzhong, Shanxi (CN)

(72) Inventors: Shiyao FAN, Jinzhong (CN); Yingjing LIANG, Jinzhong (CN); Ning LV, Jinzhong (CN); Lin FAN, Jinzhong (CN); Qihui WANG, Jinzhong (CN); Huanjing YAN, Jinzhong (CN); Huijing LIANG, Jinzhong (CN); Dongdong WU, Jinzhong (CN); Lianbao AN, Jinzhong (CN); Fangfang HAO, Jinzhong (CN); Zhiyuan GUO, Jinzhong (CN); Bin WEN, Jinzhong (CN)

(21) Appl. No.: 17/044,287

(22) PCT Filed: Oct. 24, 2018
(86) PCT No.: PCT/CN2018/111578

§ 371 Date: Dec. 4, 2020

(30) Foreign Application Priority Data
Apr. 27, 2018 (CN) 201810394762.2

(51) Int. Cl. F03B 13/26; F03B 13/14

(52) U.S. Cl. CPC F03B 13/264; F05B 2220/706; F05B 2220/32; F03B 13/14

(57) ABSTRACT

Disclosed is a power-adjustable wave power generator, comprising a support platform (1), a power generator (2), a rotary shaft (3), an impeller rod (4), a blade frame (6), blades (7), a synchronous movement mechanism and a lifting mechanism. The power generator (2) is arranged on the support platform (1) and connected to the support platform (1). The impeller rod (4) is radially connected to the rotary shaft (3). The blade frame (6), which is provided with several blades (7), is slidably connected to the impeller rod (4). The synchronous movement mechanism adjusts the distance of the frame (6) relative to the rotary shaft (3). The lifting mechanism adjusts the angle of the blades. The power generator can not only effectively generate power under the condition of small waves, but also can adjust extracted energy according to a full load of power generation when a wave force remains unchanged, and can automatically prevent a disaster under the condition of a catastrophic climate.

### FIELD OF THE PRESENT DISCLOSURE

The present invention relates to the field of new clean energy, and in particular to a wave power generation technology, and provides a power-adjustable wave power generator.

### BACKGROUND OF THE PRESENT DISCLOSURE

With the development of economy around the world, the rapid increase of population, and the progress of society, people's demand for energy is increasing. The ocean, which covers 70% of the Earth's surface, contains 97% of all water on Earth and contains massive energy, including wave energy, tidal energy, ocean current energy, temperature difference energy, and salinity gradient energy. Among them, wave energy is the highest grade ocean energy due to its minimal impact on the environment and its form as mechanical energy. As theoretically estimated, the potential of wave energy throughout the world is on the order of (10⁹) kW, which is hundreds of times the world's current power production, so that it has broad commercial prospects and is therefore the focus of ocean energy research and development in various countries.

Ocean wave energy is a clean, pollution-free and abundant renewable new energy. China's coastline is long and tortuous and contains abundant ocean wave energy resources, and exploitation and utilization of ocean wave energy is of great significance to alleviate China's energy crisis. Wave energy refers to kinetic energy and potential energy of ocean surface waves.

According to the intermediate energy transformation process, there are mainly three types of power generation from wave energy, i.e., mechanical, pneumatic and hydraulic power generation, all of which develop and utilize potential energy of waves. Mechanical power generation is to transfer reciprocating motions into unidirectional rotation motions through a transmission mechanism to drive a power generator to generate power. Pneumatic power generation is to convert wave energy into air energy by an air pumping device such as an air chamber or an air bag, and then drive a power generator to generate power by a gas turbine. Hydraulic power generation is to convert wave energy into pressure energy or potential energy of liquid (oil or sea water) by a liquid pumping device, and then drive a power generator to generate power by an oil pressure motor or a water turbine.

All the three types of wave energy power generation described above utilize the potential energy of ocean surface. However, the kinetic energy of waves is far greater than the potential energy, and of course, is far more difficult to extract than potential energy because it requires higher energy extraction capacity. Besides, power cannot be effectively generated under the condition of small waves, and the generated power cannot be adjusted when a wave force remains unchanged. Moreover, in case of catastrophic waves, accidents are prone to occur, so that it cannot be used in actual production.

### SUMMARY OF THE PRESENT DISCLOSURE

The present invention provides a power-adjustable wave power generator in order to solve the problems of low energy extraction capacity, low power generation efficiency, incapability of adjusting generated power and proneness to accidents in conventional wave power generation.

The present invention is implemented by adopting the following technical scheme: a power-adjustable wave power generator comprises a support platform arranged at sea; a power generator is arranged on the support platform, a rotary shaft is arranged below an input shaft of the power generator and connected thereto, a plurality of radially arranged impeller rods are uniformly distributed on the rotary shaft, the rotary shaft is sleeved with a control power supply interface on a lower side of the support platform, a blade frame is provided on each impeller rod and is radially slidable along the impeller rod, a plurality of blades which are distributed in the up-down direction are arranged in the blade frame, all the blades in each blade frame form a shape of louver and are provided with a blade lifting rod hinged thereto, and a synchronous movement mechanism and a lifting mechanism are arranged around the rotary shaft.

In the design of the structure, one half of the blade frame is with the current while the other half is against the current. The blades in the half of the blade frame against the current are freely opened under the action of resistance, and the blades in the half of the blade frame with the current are automatically closed under the action of thrust. In order to control the magnitude of torque, the blade lifting rods can be pulled by the lifting mechanism, thereby controlling the extent to which the blades in the half with the current are opened, and thus adjusting the water shutter. The synchronous movement mechanism drives the blade frame to move radially along the impeller rod so as to adjust the distance from the center of the blade frame to the axis of the rotary shaft to adjust the magnitude, namely, to adjust the radius of the force center of the blade frame, in which case the larger the radius of the force center of the blade frame is, the larger a moment is generated, and the smaller the radius of the force center of the blade frame is, the smaller a moment is generated. By adjusting the water shutter or the magnitude or their combination, the power of the wave power generator is adjusted, and the wave power generator can not only effectively generate power under the condition of small waves, but also can adjust extracted energy according to a full load of power generation when a wave force remains unchanged, and can automatically prevent a disaster under the condition of a catastrophic climate, thereby ensuring safety during power generation. The problems of low energy extraction capacity, low power generation efficiency, incapability of adjusting generated power and proneness to accidents in conventional wave power generation are solved.

A speed increaser is arranged above the support platform between the rotary shaft and the power generator, an input shaft of the speed increaser is connected to a lower end of the rotary shaft, and an output shaft of the speed increaser is connected to the input shaft of the power generator.

With the speed increaser, the effect of power generation is further improved.

The rotary shaft is an elastic shaft.

When the wave power generator operates, instantaneous water current change into the opposite direction can generate a moment in the same direction. With the elastic shaft, the continuity is ensured when instantaneous water current change occurs.

The synchronous movement mechanism comprises a magnitude adjusting power mechanism and connecting pins in one-to-one correspondence with the blade frames. A magnitude adjusting roller and a belt wheel are provided at two ends of the connecting pin. A synchronous transmission belt connects all the belt wheels from the external. A blade frame stay wire holder is arranged on the top of the blade frame. A magnitude adjusting fixed pulley is arranged at an upper end of the outer side of the impeller rod. A magnitude adjusting steel stranded wire with two ends being connected to the blade frame stay wire holder is wound between each magnitude adjusting fixed pulley and the corresponding magnitude adjusting roller. A power output end of the magnitude adjusting power mechanism is connected to any of the connecting pins. The lifting mechanism comprises a water shutter adjusting power mechanism. Two power output ends of the water shutter adjusting power mechanism are connected to two lifting rollers arranged at corresponding positions. Each lifting roller is provided therebelow a correspondingly positioned lifting fixed pulley. A plurality of guide rods which are slidable up and down are arranged around the rotary shaft. A guide rod stay wire holder is provided on each guide road. A lifting steel stranded wire with two ends being connected to the guide rod stay wire holder is wound between each lifting roller and the corresponding lifting fixed pulley. A lifting frame is arranged at the upper ends of the guide rods. A groove for mating with each blade lifting rod is provided in the lower surface of the lifting frame.

During the adjustment of the magnitude, the magnitude adjusting power mechanism drives one of the connecting pins to rotate, and then all the connecting pins and all the magnitude adjusting rollers are driven to rotate by the belt wheels and the synchronous transmission belt, and the magnitude adjusting steel stranded wires and the blade frame stay wire holders are driven to move by the magnitude adjusting rollers and the corresponding magnitude adjusting fixed pulleys, thereby moving the blade frames radially, and thus adjusting the magnitude is completed. During the adjustment of the water shutter, the blade frame is moved to a closest position to the rotary shaft, and then the blade lifting rod is inserted into the groove of the lifting frame, the water shutter adjusting power mechanism drives the lifting roller to rotate, the lifting roller and the corresponding lifting fixed pulley drive the lifting steel stranded wire and the guide rod stay wire holder to move up and down, the guide rod stay wire holder drives the guide rod and the guide frame to move up and down, and then the blade lifting rod can be moved up and down, thereby adjusting the blades at any angle, and thus adjusting the water shutter is completed.

The power-adjustable wave power generator further comprises an elevating mechanism arranged around the rotary shaft. The elevating mechanism comprises an underwater power mechanism, a transmission gear is provided on an output shaft of the underwater power mechanism, and a rack meshing with the transmission gear is arranged on a lower side wall of the rotary shaft.

During operation, the underwater power mechanism drives the transmission gear to rotate so as to drive the rack, the rotary shaft, the impeller rod and the blade frame to move downwards, and the whole wave power generator is moved into water to a certain depth, thereby adjusting the power of the wave power generator.

A rotary frame is arranged around the rotary shaft, the rotary frame is connected to the impeller rods, and the synchronous movement mechanism and the lifting mechanism are arranged in the rotary frame.

A rotary frame is arranged around the rotary shaft, the rotary frame is connected with the impeller rods, and the synchronous movement mechanism, the lifting mechanism and the elevating mechanism are arranged in the rotary frame.

With the rotary frame, the structure is more reasonable and reliable, and the stability of connection of the impeller rods is guaranteed.

According to the present invention, the power-adjustable wave power generator has a reasonable and reliable structural design. By the cooperation of water shutter adjustment, magnitude adjustment and underwater depth adjustment, the power generator can not only effectively generate power under the condition of small waves, but also can adjust extracted energy according to a full load of power generation when a wave force remains unchanged, and can automatically prevent a disaster under the condition of a catastrophic climate, thereby ensuring safety during power generation. Furthermore, the power-adjustable wave power generator can adjust the power at any time during normal operation, and thus has the advantages of simple structure, convenient manufacture and low cost.

### BRIEF DESCRIPTION OF THE DRAWINGS

FIG. 1 is a schematic diagram showing the structure of a power-adjustable wave power generator of the present invention;

FIG. 2 is a top view of FIG. 1;

FIG. 3 is a schematic diagram showing the structure of a synchronous movement mechanism in FIG. 1;

FIG. 4 is a schematic diagram showing the structure of a lifting mechanism in FIG. 1; and

FIG. 5 is a schematic diagram showing the structure of an elevating mechanism in FIG. 1.

### LIST OF REFERENCE NUMBERS IN THE FIGURES

1 support platform

2 power generator

3 rotary shaft

4 impeller rod

5 control power supply interface

6 blade frame

7 blade

8 blade lifting rod

9 speed increaser

10 magnitude adjusting power mechanism

11 connecting pin

12 magnitude adjusting roller

13 belt wheel

14 synchronous transmission belt

15 blade frame stay wire holder

16 magnitude adjusting fixed pulley

17 magnitude adjusting steel stranded wire

18 water shutter adjusting power mechanism

19 lifting roller

20 lifting fixed pulley

21 guide rod

22 guide rod stay wire holder

23 lifting steel stranded wire

24 lifting frame

25 rotary frame

26 underwater power mechanism

27 transmission gear

28 rack

### DESCRIPTION OF THE EMBODIMENTS

A power-adjustable wave power generator comprises a support platform 1 arranged on the sea; a power generator 2 is arranged on the support platform 1, a rotary shaft 3 is arranged below an input shaft of the power generator 2 and connected thereto, a plurality of radially arranged impeller rods 4 are uniformly distributed on the rotary shaft 3, the rotary shaft 3 is sleeved with a control power supply interface 5 on a lower side of the support platform 1, a blade frame 6 is provided on each impeller rod 4 and is radially slidable along the impeller rod 4, a plurality of blades 7 which are distributed in the up-down direction are arranged in the blade frame 6, all the blades in each blade frame 6 form a shape of louver and are provided with a blade lifting rod 8 hinged therewith, and a synchronous movement mechanism and a lifting mechanism are arranged around the rotary shaft 3.

A speed increaser 9 is arranged above the support platform 1 between the rotary shaft 3 and the power generator 2, an input shaft of the speed increaser 9 is connected to a lower end of the rotary shaft 3, and an output shaft of the speed increaser 9 is connected to the input shaft of the power generator 2.

The rotary shaft 3 is an elastic shaft.

The synchronous movement mechanism comprises a magnitude adjusting power mechanism 10 and connecting pins 11 in one-to-one correspondence with the blade frames 6, a magnitude adjusting roller 12 and a belt wheel 13 are provided at two ends of the connecting pin 11, a synchronous transmission belt 14 connects all the belt wheels 13 from the external, a blade frame stay wire holder 15 is arranged on the top of the blade frame 6, a magnitude adjusting fixed pulley 16 is arranged at an upper end of the outer side of the impeller rod 4, a magnitude adjusting steel stranded wire 17 with two ends being connected to the blade frame stay wire holder 15 is wound between each magnitude adjusting fixed pulley 16 and the corresponding magnitude adjusting roller 12, and a power output end of the magnitude adjusting power mechanism 10 is connected to any of the connecting pins 11; and the lifting mechanism comprises a water shutter adjusting power mechanism 18, two power output ends of the water shutter adjusting power mechanism 18 are connected to two lifting rollers 19 arranged at corresponding positions, each lifting roller 19 is provided therebelow a correspondingly positioned lifting fixed pulley 20, a plurality of guide rods 21 which are slidable up and down are arranged around the rotary shaft 3, a guide rod stay wire holder 22 is provided on the guide road 21, a lifting steel stranded wire 23 with two ends being connected to the guide rod stay wire holder 22 is wound between each lifting roller 19 and the corresponding lifting fixed pulley 20, a lifting frame 24 is arranged at the upper ends of the guide rods 21, and a groove for mating with each blade lifting rod 8 is provided in the lower surface of the lifting frame 24.

The power-adjustable wave power generator further comprises an elevating mechanism arranged around the rotary shaft 3; the elevating mechanism comprises an underwater power mechanism 26, a transmission gear 27 is provided on an output shaft of the underwater power mechanism 26, and a rack 28 meshing with the transmission gear 27 is arranged on a lower side wall of the rotary shaft 3.

A rotary frame 25 is arranged around the rotary shaft 3, the rotary frame 25 is connected with the impeller rods 4, and the synchronous movement mechanism and the lifting mechanism are arranged in the rotary frame 25.

A rotary frame 25 is arranged around the rotary shaft 3, the rotary frame 25 is connected with the impeller rods 4, and the synchronous movement mechanism, the lifting mechanism and the elevating mechanism are arranged in the rotary frame 25.

In implementation, the magnitude adjusting power mechanism 10, the water shutter adjusting power mechanism 18 and the underwater power mechanism are all formed by a motor and a speed reducer; the control power supply interface 5 is formed by a plurality of pairs of electric brushes and slip rings and is used for supplying power to the motor; and the rotary shaft 3 can also be connected by means of an elastic coupling for energy storage.

When water acts on the blades 7, hydraulic power is transmitted to the blade frame 6 via the blades 7 and then transmitted to the impeller rod 4 and the rotary shaft 3 via the blade frame 6, the rotary shaft 3 rotates the input of the speed increaser 9, and the speed increaser 9 drives the power generator 2 to generate power.

In case of excessive wave force, for example big waves that may cause a disaster, in order to ensure the safety of production, firstly, the magnitude adjusting power mechanism is started to adjust the magnitude of the radius of the blade frame 6 to the minimum, and then the water shutter adjusting power mechanism 18 is started to lift all the blades 7 to stop power generation, so that the safety of equipment is ensured.

The support platform 1 is fixed to a floating object or to the shore.

For the power-adjustable wave power generator, only the impeller and the blades are in contact with sea waves (sea water), and other parts are not in contact with the sea waves (sea water). The wave power generator can generate power by utilizing three kinds of energy, namely wave energy, tidal energy and ocean current energy, alone or in combination.

1. A power-adjustable generator activated by wave, ocean current or tide, wherein the generator comprises a support platform (1) arranged on the sea; a power generator (2) is arranged on the support platform (1), a rotary shaft (3) is arranged below an input shaft of the power generator (2) and connected thereto, a plurality of radially arranged impeller rods (4) are uniformly distributed on the rotary shaft (3), the rotary shaft (3) is sleeved with a control power supply interface (5) on a lower side of the support platform (1), a blade frame (6) is provided on each impeller rod (4) and is radially slidable along the impeller rod (4), a plurality of blades (7) which are distributed in the up-down direction are arranged in the blade frame (6), all the blades in each blade frame (6) form a shape of louver and are provided with a blade lifting rod (8) hinged thereto, and a synchronous movement mechanism and a lifting mechanism are arranged around the rotary shaft (3).

2. The power-adjustable generator activated by wave, ocean current or tide according to claim 1, wherein a speed increaser (9) is arranged above the support platform (1) between the rotary shaft (3) and the power generator (2), an input shaft of the speed increaser (9) is connected to a lower end of the rotary shaft (3), and an output shaft of the speed increaser (9) is connected to the input shaft of the power generator (2).

3. The power-adjustable generator activated by wave, ocean current or tide according to claim 1, wherein the rotary shaft (3) is an elastic shaft.

4. The power-adjustable generator activated by wave, ocean current or tide according to claim 1, wherein the synchronous movement mechanism comprises a magnitude adjusting power mechanism (10) and connecting pins (11) in one-to-one correspondence with the blade frames (6), a magnitude adjusting roller (12) and a belt wheel (13) are provided at two ends of the connecting pin (11), a synchronous transmission belt (14) connects all the belt wheels (13) from the external, a blade frame stay wire holder (15) is arranged on the top of the blade frame (6), a magnitude adjusting fixed pulley (16) is arranged at an upper end of the outer side of the impeller rod (4), a magnitude adjusting steel stranded wire (17) with two ends being connected to the blade frame stay wire holder (15) is wound between each magnitude adjusting fixed pulley (16) and the corresponding magnitude adjusting roller (12), and a power output end of the magnitude adjusting power mechanism (10) is connected to any of the connecting pins (11);
the lifting mechanism comprises a water shutter adjusting power mechanism (18), two power output ends of the water shutter adjusting power mechanism (18) are connected to two lifting rollers (19) arranged at corresponding positions, each lifting roller (19) is provided therebelow a correspondingly positioned lifting fixed pulley (20), a plurality of guide rods (21) which are slidable up and down are arranged around the rotary shaft (3), a guide rod stay wire holder (22) is provided on the guide road (21), a lifting steel stranded wire (23) with two ends being connected to the guide rod stay wire holder (22) is wound between each lifting roller (19) and the corresponding lifting fixed pulley (20), a lifting frame (24) is arranged at the upper ends of the guide rods (21), and a groove for mating with each blade lifting rod (8) is provided in the lower surface of the lifting frame (24).

5. The power-adjustable generator activated by wave, ocean current or tide according to claim 3, wherein the synchronous movement mechanism comprises a magnitude adjusting power mechanism (10) and connecting pins (11) in one-to-one correspondence with the blade frames (6), a magnitude adjusting roller (12) and a belt wheel (13) are provided at two ends of the connecting pin (11), a synchronous transmission belt (14) connect all the belt wheels (13) from the external, a blade frame stay wire holder (15) is arranged on the top of the blade frame (6), a magnitude adjusting fixed pulley (16) is arranged at an upper end of the outer side of the impeller rod (4), a magnitude adjusting steel stranded wire (17) with two ends being connected to the blade frame stay wire holder (15) is wound between each magnitude adjusting fixed pulley (16) and the corresponding magnitude adjusting roller (12), and a power output end of the magnitude adjusting power mechanism (10) is connected to any of the connecting pins (11);
the lifting mechanism comprises a water shutter adjusting power mechanism (18), two power output ends of the water shutter adjusting power mechanism (18) are connected to two lifting rollers (19) arranged at corresponding positions, each lifting roller (19) is provided therebelow a correspondingly positioned lifting fixed pulley (20), a plurality of guide rods (21) which are slidable up and down are arranged around the rotary shaft (3), a guide rod stay wire holder (22) is provided on the guide road (21), a lifting steel stranded wire (23) with two ends being connected to the guide rod stay wire holder (22) is wound between each lifting roller (19) and the corresponding lifting fixed pulley (20), a lifting frame (24) is arranged at the upper ends of the guide rods (21), and a groove for mating with each blade lifting rod (8) is provided in the lower surface of the lifting frame (24).

6. The power-adjustable generator activated by wave, ocean current or tide according to claim 1, further comprising an elevating mechanism arranged around the rotary shaft (3); the elevating mechanism comprises an underwater power mechanism (26), a transmission gear (27) is provided on an output shaft of the underwater power mechanism (26), and a rack (28) meshing with the transmission gear (27) is arranged on a lower side wall of the rotary shaft (3).

7. The power-adjustable generator activated by wave, ocean current or tide according to claim 5, further comprising an elevating mechanism arranged around the rotary shaft (3); the elevating mechanism comprises an underwater power mechanism (26), a transmission gear (27) is provided on an output shaft of the underwater power mechanism (26), and a rack (28) meshing with the transmission gear (27) is arranged on a lower side wall of the rotary shaft (3).

8. The power-adjustable generator activated by wave, ocean current or tide according to claim 1, wherein a rotary frame (25) is arranged around the rotary shaft (3), the rotary frame (25) is connected with the impeller rods (4), and the synchronous movement mechanism and the lifting mechanism are arranged in the rotary frame (25).

9. The power-adjustable generator activated by wave, ocean current or tide according to claim 7, wherein a rotary frame (25) is arranged around the rotary shaft (3), the rotary frame (25) is connected with the impeller rods (4), and the synchronous movement mechanism, the lifting mechanism and the elevating mechanism are arranged in the rotary frame (25).)

10. The power-adjustable generator activated by wave, ocean current or tide according to claim 2, wherein the synchronous movement mechanism comprises a magnitude adjusting power mechanism (10) and connecting pins (11) in one-to-one correspondence with the blade frames (6), a magnitude adjusting roller (12) and a belt wheel (13) are provided at two ends of the connecting pin (11), a synchronous transmission belt (14) connects all the belt wheels (13) from the external, a blade frame stay wire holder (15) is arranged on the top of the blade frame (6), a magnitude adjusting fixed pulley (16) is arranged at an upper end of the outer side of the impeller rod (4), a magnitude adjusting steel stranded wire (17) with two ends being connected to the blade frame stay wire holder (15) is wound between each magnitude adjusting fixed pulley (16) and the corresponding magnitude adjusting roller (12), and a power output end of the magnitude adjusting power mechanism (10) is connected to any of the connecting pins (11);
the lifting mechanism comprises a water shutter adjusting power mechanism (18), two power output ends of the water shutter adjusting power mechanism (18) are connected to two lifting rollers (19) arranged at corresponding positions, each lifting roller (19) is provided therebelow a correspondingly positioned lifting fixed pulley (20), a plurality of guide rods (21) which are slidable up and down are arranged around the rotary shaft (3), a guide rod stay wire holder (22) is provided on the guide road (21), a lifting steel stranded wire (23) with two ends being connected to the guide rod stay wire holder (22) is wound between each lifting roller (19) and the corresponding lifting fixed pulley (20), a lifting frame (24) is arranged at the upper ends of the guide rods (21), and a groove for mating with each blade lifting rod (8) is provided in the lower surface of the lifting frame (24).
